(19) United States
(12) Patent Application Publication
(10) Pub. No.: US 2011/0216882 A1
(43) Pub. Date: Sep. 8, 2011

(54) Radiographic image capturing method and apparatus, and radiographic image generating method and apparatus

(75) Inventor: Hiroki Nakayama, Kanagawa-ken (JP)

(73) Assignee: FUJIFILM Corporation, Tokyo (JP)

(21) Appl. No.: 12/929,522

(22) Filed: Jan. 31, 2011

(30) Foreign Application Priority Data
Mar. 4, 2010 (JP) 2010-047284

(51) Int. Cl. H05G 1/30

(52) U.S. Cl. 378/62

(57) ABSTRACT

The grid is disposed between a subject to be imaged and a solid-state detector while a radiation source and radiation-impermeable members of a grid are in such a positional relationship that the orbital plane of the radiation source which is angularly movable and the direction in which the radiation-impermeable members extend are perpendicular to each other. The radiation source is moved to an angular position through an turning angle which is up to 5° excluding 0°, from a line normal to the solid-state detector. The radiation source moved to the angular position applies a radiation obliquely to the subject.

### CROSS-REFERENCE TO RELATED APPLICATION

This application is based upon and claims the benefit of priority from Japanese Patent Application No. 2010-047284 filed on Mar. 4, 2010, of which the contents are incorporated herein by reference.

### BACKGROUND OF THE INVENTION

1. Field of the Invention

The present invention relates to a radiographic image capturing method and apparatus and a radiographic image generating method and apparatus which employ a grid for removing scattered rays of a radiation that is applied to a radiation detector, the grid comprising an assembly formed by alternately arranging radiation-permeable members and radiation-impermeable members which extend in one direction.

2. Description of the Related Art

Heretofore, radiographic image capturing apparatus, such as an X-ray image capturing apparatus used in the medical field, employ a grid in a radiographic image capturing process. The grid is disposed between a subject whose radiographic image is to be captured and a radiation detector for detecting a radiation that has passed through the subject. When a radiation emitted from a radiation source passes through the subject, it is divided into a straightforward component and a scattered component. The grid is capable of effectively removing the scattered component that is responsible for a reduction in the quality, especially sharpness, of a radiographic image which is generated based on the radiation detected by the radiation detector.

Generally, the grid has a structure comprising an array of radiation-impermeable members such as lead plates or the like spaced at certain intervals. One known grid called “focused grid” has radiation-impermeable members inclined to the direction in which a radiation emitted from a radiation source and then transmitted through a subject is applied to the grid, for thereby increasing the efficiency with which the straightforward component of the radiation passes through the grid. The focused grid is constructed on the assumption that the radiation is applied to the focused grid in a frontal direction thereof, i.e., a frontal image of the subject is to be captured.

Biopsy apparatus for sampling a body tissue from a biopsy region in a mass to be inspected of a subject are required to identify a three-dimensional position of the biopsy region in advance in order to reliably sample the body tissue. To meet the requirement, it has been customary for the biopsy apparatus to carry out a stereographic image capturing process for applying a radiation from a radiation source which is located successively at two different angular positions to a mass to be inspected and detecting the radiation that has passed through the mass with a radiation detector for thereby acquiring two radiographic images of the mass, and then calculate a three-dimensional position of the biopsy region based on the two radiographic images.

When the radiation source is positioned obliquely to the grid and emits the radiation from the oblique position, then an angular difference occurs between the direction in which the radiation-impermeable members of the grid are erected and the direction in which the radiation is applied to the grid. Therefore, the straightforward component of the radiation that has passed through the subject is obstructed by the radiation-impermeable members and hindered from passing through the grid. As a result, the dose of the radiation that reaches the radiation detector is reduced. Such a phenomenon is referred to as “radiation vignetting”.

If the radiation dose detected by the radiation detector is relatively small due to the radiation vignetting, then since the value of a signal output by the radiation detector which represents image information is small, the SN (Signal-to-Noise) ratio of the entire image detecting system is reduced. As a result, the imaging capability for a body region where the radiation absorption contrast is low, is decreased.

One approach to solving the above drawback is to determine whether the grid is required or not depending on the image capturing process to be performed. More specifically, the grid is inserted for a frontal image capturing process, and the grid is removed for a stereographic image capturing process. However, it is a time-consuming task to manually insert and remove the grid. If image capturing conditions vary depending on whether the grid is present or not, then an irradiation dose, a positioning setting, etc. need to be finely adjusted each time a radiographic image is to be captured. Another solution is to select a focused grid having a shape suitable for a certain angular position of the radiation source in a stereographic image capturing process. However, it is tedious and time-consuming to select different focused grids for different angular positions of the radiation source.

Radiographic image capturing apparatus may incorporate a grid that can be moved to an appropriate position and attitude when or before a radiographic image is captured. Though the movable grid is effective to minimize decrease in image quality due to radiation vignetting, the addition of a mechanism for moving the grid tends to make the radiographic image capturing apparatus large in size and high in cost.

Japanese Laid-Open Patent Publication No. 2008-086471 discloses an apparatus having a tiling means for tilting a focused grid into an angular position where a straight line interconnecting the focal point of the focused grid and a radiation source extends perpendicularly to the focused grid.

Japanese Laid-Open Patent Publication No. 2007-215929 discloses a method of and an apparatus for moving a grid while gradually changing a return position thereof each time the grid reciprocates (for example, see FIGS. 8 and 10 of Japanese Laid-Open Patent Publication No. 2007-215929).

Japanese Laid-Open Patent Publication No. 2008-237631 discloses an apparatus for moving a grid back and forth in directions perpendicular to the direction in which the radiation-impermeable members extend, while a radiation is being applied to the grid.

### SUMMARY OF THE INVENTION

The present invention has been made in relation to the technical concepts disclosed in Japanese Laid-Open Patent Publication No. 2008-086471, Japanese Laid-Open Patent Publication No. 2007-215929, and Japanese Laid-Open Patent Publication No. 2008-237631.

It is an object of the present invention to provide a radiographic image capturing method and apparatus and a radiographic image generating method and apparatus which are capable of performing a stereographic image capturing process while minimizing deterioration in an imaging capability for a body region where a radiation absorption contrast is low, and which are of a simple arrangement and are relatively low in cost of manufacturing.

According to an aspect of the present invention, there is provided a radiographic image capturing method using a grid for removing scattered rays of a radiation applied to a radiation detector, the grid including an assembly formed by alternately arranging radiation-permeable members and radiation-impermeable members which extend in one direction.

The radiographic image capturing method comprises the steps of placing the grid between a subject to be imaged and the radiation detector in such a positional relationship that an orbital plane of the radiation source which is angularly movable and the one direction are perpendicular to each other, moving the radiation source to an angular position through an angle which is up to 5° (except 0°) from a line normal to the radiation detector, and applying the radiation from the radiation source which has been moved to the angular position, obliquely to the subject.

As described above, the grid is disposed such that the orbital plane of the radiation source and the one direction are perpendicular to each other, and the radiation source is moved to an angular position through a turning angle which is up to 5° (except 0°) from the line normal to the radiation detector, after which a radiographic image is captured. Thus, any angular difference between the direction in which the radiation-impermeable members of the grid are erected and the direction in which the radiation is applied to the grid is small. Therefore, the straightforward component of the radiation which has passed through the subject passes through the radiation-permeable members essentially without being obstructed by the radiation-impermeable members, and reaches the radiation detector. The SN ratio of an entire image detecting system including a radiographic image capturing apparatus which carries out the radiographic image capturing method is maintained at a desired level, and as a result, the imaging capability for a body region where the absorption contrast for the radiation is low is prevented from being decreased. The radiographic image capturing apparatus is of a simple arrangement and is hence relatively low in cost of manufacturing.

Preferably, the grid comprises a focused grid in which the radiation-impermeable members are inclined at respective angles that are progressively greater away from a central line of the grid, the central line extending along the one direction.

According to another aspect of the present invention, there is also provided a radiographic image capturing apparatus comprising a radiation source for emitting a radiation, a drive controller for actuating the radiation source to turn along an orbit, a grid for removing scattered rays of the radiation, the grid including an assembly formed by alternately arranging radiation-permeable members and radiation-impermeable members which extend in one direction, and a radiation detector for detecting the radiation emitted from the radiation source, wherein the grid is disposed between a subject to be imaged and the radiation detector in such a positional relationship that an orbital plane of the radiation source and the one direction are perpendicular to each other, the drive controller moves the radiation source to an angular position through an angle which is up to 5° (except 0°) from a line normal to the radiation detector, and the radiation detector detects the radiation which is emitted from the radiation source which has been moved to the angular position, obliquely to the subject.

Preferably, the grid comprises a focused grid in which the radiation-impermeable members are inclined at respective angles that are progressively greater away from a central line of the grid, the central line extending along the one direction.

According to still another aspect of the present invention, there is also provided a radiographic image generating method using a grid for removing scattered rays of a radiation applied to a radiation detector, the grid including an assembly formed by alternately arranging radiation-permeable members and radiation-impermeable members which extend in one direction.

The radiographic image generating method comprises the steps of placing the grid between a subject to be imaged and the radiation detector in such a positional relationship that an orbital plane of the radiation source which is angularly movable and the one direction are perpendicular to each other, determining at least two angles in a range from −5° through 5° with respect to a line normal to the radiation detector, as turning angles through which the radiation source is to be turned along an orbit, and moving the radiation source to respective angular positions depending on the determined turning angles, applying the radiation from the radiation source at the angular positions, to the subject, and acquiring radiographic images of the subject depending on the respective turning angles.

Preferably, the radiographic image generating method further comprises the step of generating a reconstructed image by reconstructing the acquired radiographic images depending on the respective turning angles.

According to yet another aspect of the present invention, there is also provided a radiographic image generating apparatus comprising a radiation source for emitting a radiation, a drive controller for actuating the radiation source to turn along an orbit, a grid for removing scattered rays of the radiation, the grid including an assembly formed by alternately arranging radiation-permeable members and radiation-impermeable members which extend in one direction, and a radiation detector for detecting the radiation emitted from the radiation source, wherein the grid is disposed between a subject to be imaged and the radiation detector in such a positional relationship that an orbital plane of the radiation source and the one direction are perpendicular to each other, the drive controller moves the radiation source to respective angular positions through at least two turning angles in a range from −5° through 5° from a line normal to the radiation detector, and the radiation detector detects the radiation which is emitted from the radiation source at each of the angular positions to the subject.

Preferably, the radiographic image generating apparatus further comprises a radiographic image generator for acquiring radiographic images depending on the respective turning angles based on the radiation detected by the radiation detector, and generating a reconstructed image by reconstructing the acquired radiographic images.

With the radiation image capturing method and the radiation image capturing apparatus according to the present invention, the grid is placed between a subject to be imaged and the radiation detector in such a positional relationship that an orbital plane of the radiation source which is angularly movable and the one direction in which the radiation-impermeable members extend are perpendicular to each other. The radiation source is moved to an angular position through an angle which is up to 5° (except 0°) from a line normal to the radiation detector, and the radiation is applied from the radiation source which has been moved to the angular position, obliquely to the subject. Consequently, any angular difference between the direction in which the radiation-impermeable members of the grid are erected and the direction in which the radiation is applied to the grid is small.

With the radiation image generating method and the radiation image generating apparatus according to the present invention, the grid is placed between a subject to be imaged and the radiation detector in such a positional relationship that an orbital plane of the radiation source which is angularly movable and the one direction in which the radiation-impermeable members extend are perpendicular to each other. At least two angles in a range from −5° through 5° with respect to the normal line of the radiation detector are determined as turning angles through which the radiation source is to be turned along an orbit, and the radiation source is moved to respective angular positions depending on the determined turning angles. The radiation is applied from the radiation source at each of the angular positions, to the subject, and radiographic images of the subject depending on the respective angles are acquired based on the radiation which has passed through the subject. Consequently, any angular difference between the direction in which the radiation-impermeable members of the grid are erected and the direction in which the radiation is applied to the grid is small.

Therefore, the straightforward component of the radiation which has passed through the subject passes through the radiation-permeable members essentially without being obstructed by the radiation-impermeable members, and reaches the radiation detector. The SN ratio of an entire image detecting system including a radiographic image capturing apparatus which carries out the radiographic image capturing method or a radiographic image generating apparatus which carries out the radiographic image generating method is maintained at a desired level, and as a result, the imaging capability for a body region where the absorption contrast for the radiation is low is prevented from being decreased. The radiographic image capturing apparatus is of a simple arrangement and is hence relatively low in cost of manufacturing.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a perspective view of a mammographic apparatus according to an embodiment of the present invention;

FIG. 2 is a fragmentary side elevational view showing internal structural details of an image capturing base of the mammographic apparatus shown in FIG. 1;

FIG. 3 is a perspective view of a grid of the mammographic apparatus shown in FIG. 2;

FIG. 4 is a block diagram of a control circuit of the mammographic apparatus shown in FIG. 1;

FIG. 5 is a flowchart of an operation sequence of the mammographic apparatus shown in FIG. 1;

FIG. 6 is a schematic front elevational view illustrative of a stereographic image capturing process carried out by the mammographic apparatus shown in FIG. 1;

FIG. 7 is an enlarged cross-sectional view, partly omitted from illustration, of the grid at a position near a central line;

FIG. 8 is an enlarged cross-sectional view, partly omitted from illustration, of the grid at a position spaced from the central line; and

FIG. 9 is a table showing the relationship between the radiation dose applied to a subject, the quality of a radiographic image, and an angle θ.

### DESCRIPTION OF THE PREFERRED EMBODIMENTS

A radiographic image capturing method and a radiographic image generating method according to a preferred embodiment of the present invention in relation to a radiographic image capturing apparatus and a radiographic image generating apparatus for carrying out the radiographic image capturing method and the radiographic image generating method, respectively, will be described below with reference to the accompanying drawings.

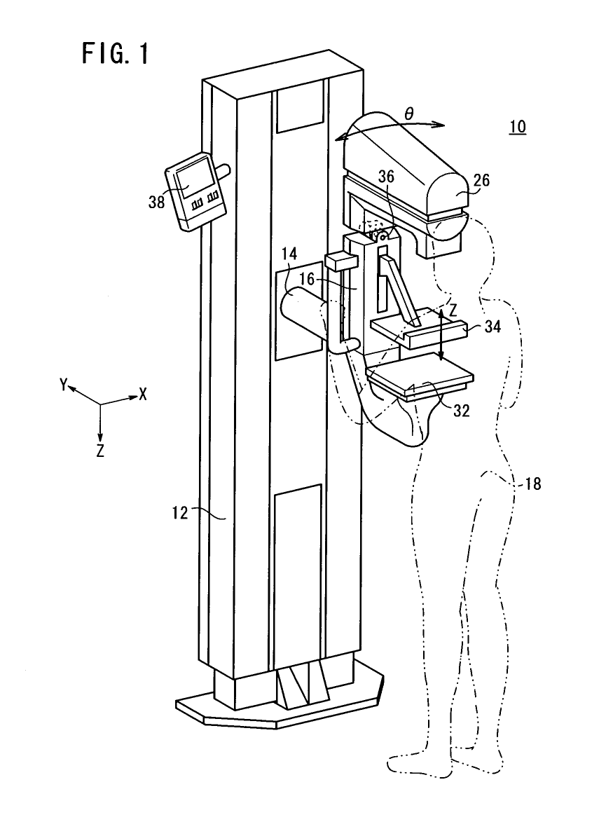

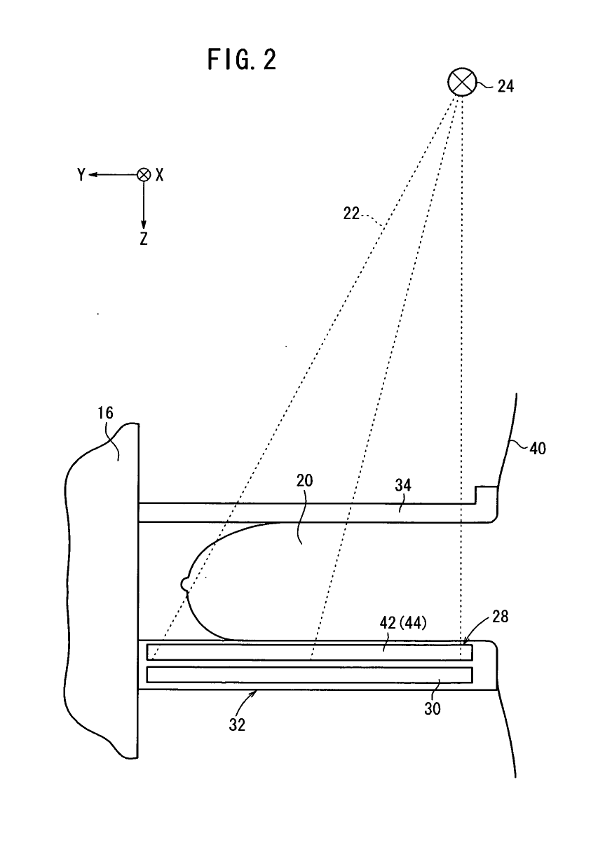

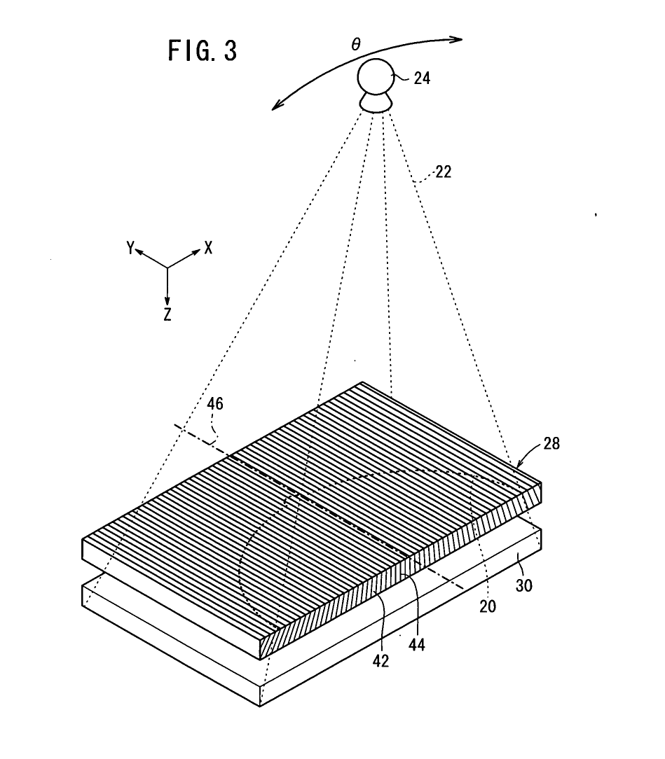

As shown in FIG. 1, a mammographic apparatus 10 which serves as a radiographic image capturing apparatus or a radiographic image generating apparatus includes an upstanding base 12, a vertical arm 16 fixed to a horizontal swing shaft 14 disposed substantially centrally on the base 12, a radiation source housing unit 26 storing a radiation source 24 (see FIGS. 2 and 3) for applying radiation 22 to a breast 20 (see FIG. 2) as a body region to be imaged of a subject 18 and fixed to an upper end of the arm 16, an image capturing base 32 housing a solid-state detector (radiation detector) 30 (see FIGS. 2 and 3) for detecting radiation 22 that has passed through the breast 20 and a grid 28 and fixed to a lower end of the arm 16, and a compression plate 34 for compressing and holding the breast 20 against the image capturing base 32.

When the arm 16, to which the radiation source housing unit 26 and the image capturing base 32 are secured, is angularly moved about the swing shaft 14 in the directions indicated by the arrow θ, an image capturing direction with respect to the breast 20 of the subject 18 is adjusted. The radiation source housing unit 26 is coupled to the arm 16 by a hinge 36 and is angularly movable in the directions indicated by the arrow θ independently of the image capturing base 32. The compression plate 34 that is coupled to the arm 16 is disposed between the radiation source housing unit 26 and the image capturing base 32. The compression plate 34 is vertically displaceable along the arm 16 in the Z-axis directions indicated by the arrow Z.

To the base 12, there is connected a display control panel 38 for displaying image capturing information including an image capturing region, an image capturing direction, etc. of the subject 18, the ID information of the subject 18, etc., and setting these items of information, if necessary.

FIGS. 2 and 3 show internal structural details of the image capturing base 32 of the mammographic apparatus 10. In FIG. 2, the breast 20, which is the body region to be imaged of the subject 18, is shown as being placed between the image capturing base 32 and the compression plate 34. The reference numeral 40 represents the chest wall of the subject 18.

The grid 28 is disposed over an upper front surface of the solid-state detector 30 and faces the radiation source 24. The grid 28 serves to remove scattered rays of the radiation 22 that are generated in the breast 20. The grid 28 comprises an assembly of radiation-permeable members 42 made of aluminum or the like which pass the radiation 22 therethrough and radiation-impermeable members 44 made of a material including lead or the like. The radiation-permeable members 42 and the radiation-impermeable members 44 are arranged alternately. The radiation-permeable members 42 and the radiation-impermeable members 44 extend in a direction perpendicular to the chest wall 40 of the subject 18 positioned against the image capturing base 32, i.e., in Y-axis direction. The Y-axis directions extend perpendicularly to an orbital plane of the radiation source 24, the orbital plane being represented generally by an X-Z plane in FIG. 3 and defined by turning of the radiation source 24 in the directions indicated by the arrow θ.

As shown in FIG. 3, the grid 28 has a central line 46 parallel to the directions of shorter sides thereof, i.e., the Y-axis directions. The central line 46 extends perpendicularly to a line normal to the plane of the grid 28, which line extends through a frontal position (θ=0°) of the radiation source 24. The grid 28 comprises a so-called focused grid wherein the radiation-impermeable members 44 are inclined to the Z-axis directions at respective angles θ that are progressively greater away from the central line 46 in alignment with the direction in which the radiation 22 is applied from the radiation source 24.

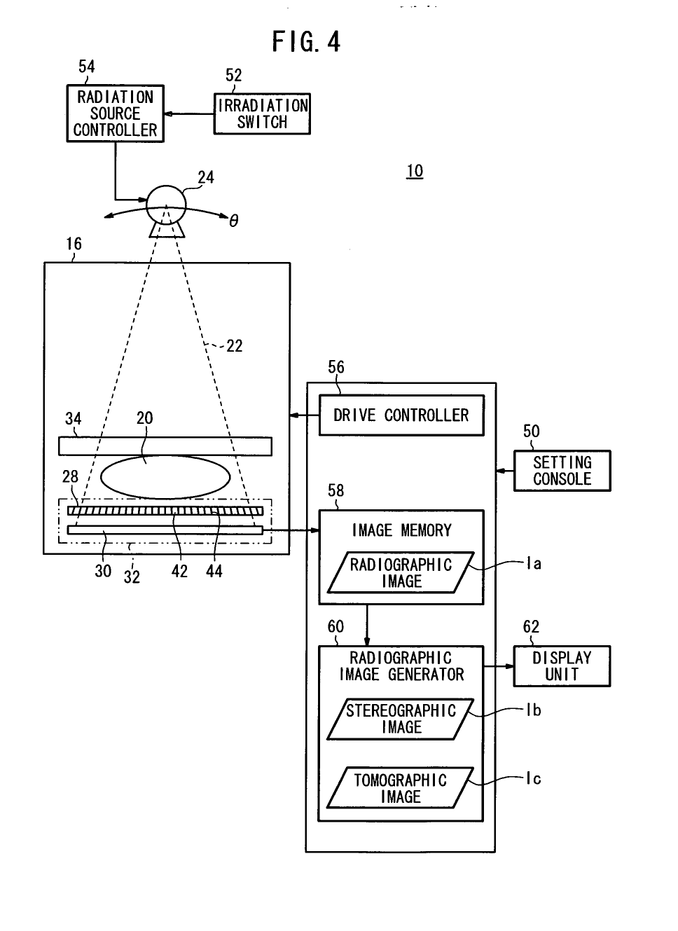

The solid-state detector 30 comprises a two-dimensional matrix of photoelectric transducers made of amorphous selenium (a-Se) or the like. The solid-state detector 30 converts the radiation 22 applied to the photoelectric transducers into an electric signal and stores radiographic image information Ia (see FIG. 4) represented by the radiation 22 as electric charge information represented by the electric signal.

FIG. 4 shows in block form a control circuit of the mammographic apparatus 10.

As shown in FIG. 4, the mammographic apparatus 10 includes a setting console 50 for setting subject information with respect to the age, sex, body type, subject identification number, etc. of the subject 18, image capturing conditions and an image capturing process for capturing the radiographic image Ia, etc., an irradiation switch 52 for turning on the radiation source 24 to emit the radiation 22 therefrom, a radiation source controller 54 for controlling the radiation source 24 to emit the radiation 22 according to the set image capturing conditions including a tube current, a tube voltage, an irradiation dose, an irradiation time, the types of a target and a filter in the radiation source 24, etc, a drive controller 56 for actuating the radiation source 24 to move along a curved orbit in the directions indicated by the arrow θ, an image memory 58 for temporarily storing the radiographic image Ia of the breast 20 which is acquired from the solid-state detector 30, a radiographic image generator 60 for generating a diagnostic image, e.g., a stereographic image Ib or a tomographic image Ic by processing the radiographic image Ia stored in the image memory 58, and a display unit 62 for displaying the generated diagnostic image.

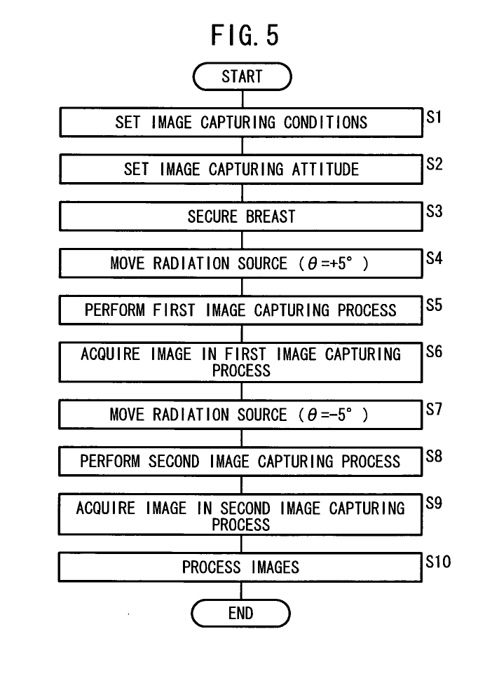

The mammographic apparatus 10 according to the present embodiment is basically constructed as described above. Operation of the mammographic apparatus 10 will be described below with reference to a flowchart shown in FIG. 5.

Using the setting console 50 (see FIG. 4) of the mammographic apparatus 10, the operator, who is typically a radiological technician, sets subject information, image capturing conditions, an image capturing process, etc. (step S1). The subject information includes information as to the age, sex, body type, subject identification number, etc. of the subject 18, and can be acquired from an ID card or the like owned by the subject 18. The image capturing conditions include a tube current, a tube voltage, the types of a target and a filter, an irradiation dose of the radiation X, etc. for acquiring a suitable radiographic image Ia depending on the breast 20 which is a body region to be imaged of the subject 18. The image capturing process represents information including a region to be imaged that is specified by the doctor, an image capturing direction that is specified by the doctor, etc. These items of information can be displayed on the display control panel 38 of the mammographic apparatus 10 for the radiological technician to confirm. If the mammographic apparatus 10 is connected to a network, these items of information can be acquired from a higher-level apparatus, through the network.

Then, as shown in FIG. 1, the radiological technician places the mammographic apparatus 10 into a certain imaging posture according to the specified image capturing process (step S2). For example, the breast 20 may be imaged as a cranio-caudal view (CC) taken from above, a medio-lateral view (ML) taken outwardly from the center of the chest, or a medio-lateral oblique view (MLO) taken from an oblique view. Depending on the information of a selected one of these image capturing directions, the radiological technician turns the arm 16 about the swing shaft 14. In FIG. 1, the mammographic apparatus 10 is set to an imaging posture for capturing a cranio-caudal view (CC) of the breast 20.

Then, the radiological technician positions the breast 20 of the subject 18 with respect to the mammographic apparatus 10. For example, the radiological technician places the breast 20 on the image capturing base 32, and thereafter lowers the compression plate 34 toward the image capturing base 32 to hold the breast 20 between the image capturing base 32 and the compression plate 34, as shown in FIG. 2 (step S3).

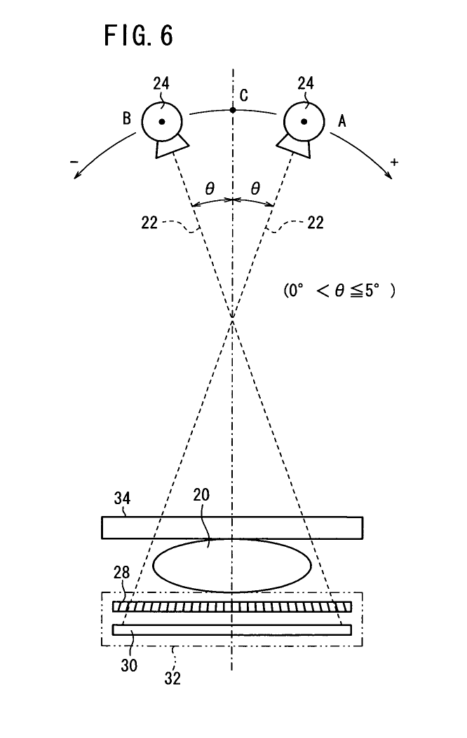

In order to perform a first radiographic capturing process, the drive controller 56 turns the radiation source housing unit 26 about the hinge 36 in a direction indicated by the arrow θ into a position A (step S4). As shown in FIG. 6, the radiation source 24 reaches the position A when the radiation source 24 is turned from the frontal position C (θ=0°) on the normal line of the solid-state detector 30 through an angle θ (0°<θ≦5°), e.g., θ=5°, in a positive direction (to the right in FIG. 6).

Then, the radiation source controller 54 controls the tube voltage, the tube current, and the irradiation time of the radiation source 24 according to the image capturing conditions set in step S1, and energizes the radiation source 24 to apply the radiation 22 to the breast 20 to capture a radiographic image Ia thereof in the first radiographic image capturing process (step S5).

The radiation 22 that is emitted from the radiation source 24 passes through the compression plate 34 and the breast 20 to the grid 28 in the image capturing base 32. The radiation 22 that has passed through the breast 20 includes a straightforward component which travels substantially in the same direction as the direction in which the radiation 22 is applied to the grid 28 and a scattered component due to scattering in the breast 20 and which travels in directions different from the direction in which the radiation 22 is applied to the grid 28.

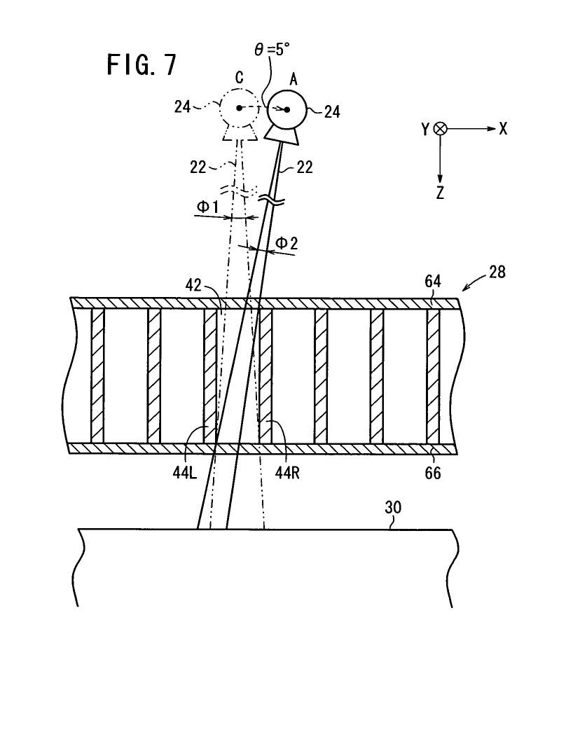

FIG. 7 is an enlarged cross-sectional view, partly omitted from illustration, of the grid 28 at a position near the central line 46 (see FIG. 3). The radiation-permeable members 42 and the radiation-impermeable members 44 which are alternately arranged in a periodic pattern are sandwiched between a first protective layer 64 in the form of a flat plate and a second protective layer 66 in the form of a flat plate that are spaced vertically from each other.

When the radiation 22 is emitted from the radiation source 24 that is disposed in the frontal position C as indicated by the two-dot-and-dash lines in FIG. 7, only a component within an angle φ1 of the straightforward component thereof passes through the grid 28 and reaches the solid-state detector 30. More specifically, the component within the angle φ1 of the straightforward component passes through the first protective layer 64, a radiation-permeable member 42 and the second protective layer 66 without being obstructed by radiation-impermeable members 44L, 44R. When the radiation 22 is emitted from the radiation source 24 that is disposed in the position A as indicated by the solid lines in FIG. 7, only a component within an angle φ2 of the straightforward component thereof passes through the grid 28 and reaches the solid-state detector 30.

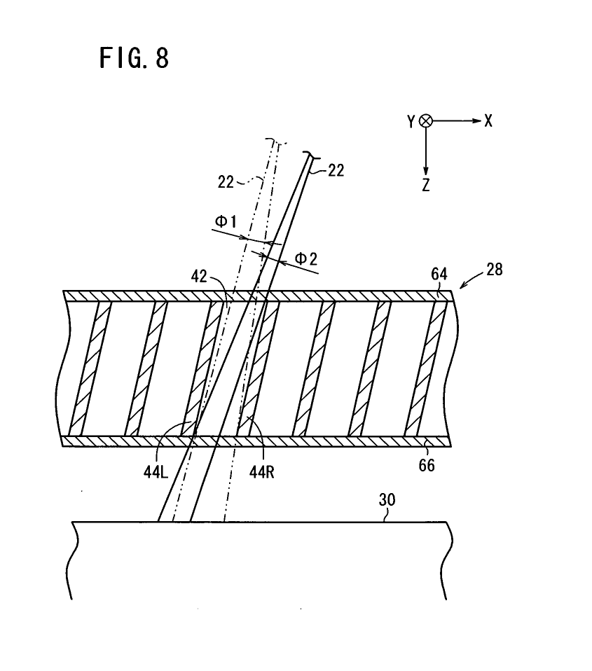

If the angle θ is in the range −5°≦θ≦5°, since any obstruction by the radiation-impermeable members 44 is small, the transmitted dose of the radiation 22 remains almost unchanged irrespective of the angle θ. FIG. 8 is an enlarged cross-sectional view, partly omitted from illustration, of the grid 28 at a position spaced from the central line 46 (see FIG. 3). In FIG. 8, the radiation-permeable members 42 and the radiation-impermeable members 44 are inclined to the Z-axis directions. In FIG. 8, if the angle θ is in the range −5°≦θ≦5°, the transmitted dose of the radiation 22 also remains almost unchanged irrespective of the angle θ, as described above with reference to FIG. 7.

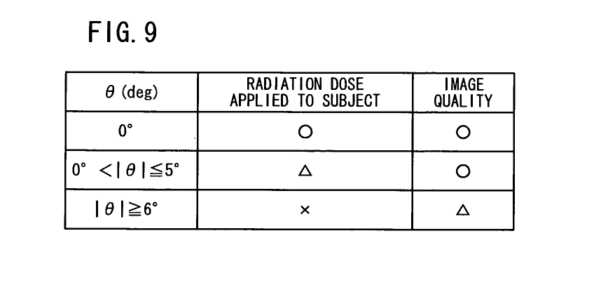

FIG. 9 is a table showing the relationship between the radiation dose applied to the subject 18, the quality of the radiographic image Ia, and the angle θ. The table shows evaluations of the radiation dose and the image quality at angles θ with the evaluation at the angle θ=0° being used as a reference.

In the table, the item “RADIATION DOSE APPLIED TO SUBJECT 18” represents evaluations of irradiation doses (radiation doses applied to the subject 18) required to achieve the same radiation doses as the radiation dose achieved at the angle θ=0°. More specifically, “◯”, “Δ”, and “x” indicate “equivalent”, “within an allowable range (1.0 through 1.3 times the radiation dose at the angle θ=0°”, and “out of the allowable range (1.3 or more times the radiation dose at the angle θ=0°”, respectively.

The item “IMAGE QUALITY” represents evaluations of physical properties (in-plane uniformity and sharpness) and image diagnostic performance as compared with those at the angle θ=0°. More specifically, “603 ” and “Δ” indicate “equivalent levels of physical properties and image diagnostic performance” and “significantly low level of physical properties and equivalent level of image diagnostic performance”, respectively.

Consequently, it is preferable to set the angle θ to the range 0°<|θ|≦5° in order to achieve an image quality level that is equivalent to the image quality level at the angle θ=0° while keeping the radiation dose applied to the subject 18 within the allowable range.

As shown in FIG. 4, the radiation 22 that has passed through the compression plate 34, the breast 20 and the grid 28, is applied to the solid-state detector 30, which records a radiographic image Ia as electric charge information. The radiographic image Ia recorded in the solid-state detector 30 is then acquired by the image memory 58 and temporarily stored therein as image information in the first radiographic capturing process (step S6).

Then, in order to perform a second radiographic capturing process, the drive controller 56 turns the radiation source housing unit 26 about the hinge 36 in a direction indicated by the arrow θ into a position B (step S7). As shown in FIG. 6, the radiation source 24 reaches the position B when the radiation source 24 is turned from the frontal position C (θ=0°) on the line normal to the solid-state detector 30 through an angle θ (−5°≦θ<0°), e.g., θ=−5°, in a negative direction (to the left in FIG. 6).

Then, the radiation source controller 54 controls the tube voltage, the tube current, and the irradiation time of the radiation source 24 according to the image capturing conditions set in step S1, and energizes the radiation source 24 to apply the radiation 22 to the breast 20 to capture a radiographic image Ia thereof in the second radiographic image capturing process (step S8). The mechanism wherein the radiation 22 passes through the breast 20 and the process up to the acquisition of the radiographic image Ia are the same as described above, and will not be described in detail below.

The radiographic image Ia captured in the second radiographic image capturing process is temporarily stored in the image memory 58 (step S9).

Finally, the radiographic images Ia thus acquired in the first and second radiographic image capturing processes when the radiation source 24 is moved in the directions indicated by the arrow θ are supplied from the image memory 58 to the radiographic image generator 60. The radiographic image generator 60 processes the supplied radiographic images Ia to produce a pair of radiographic images which jointly form a stereographic image Ib (step S9). The radiographic image generator 60 may generate the stereographic image Ib according to a known image processing sequence.

In the first and second radiographic image capturing processes, the drive controller 56 may turn the radiation source housing unit 26 through any angles θ₁, θ₂ insofar as they fall within the range −5°≦θ≦5°. For example, these angles θ₁, θ₂ may be of symmetrical values such as of (5°, −5°) or (2°, −2°) with respect to the line normal to the solid-state detector 30, or may be of asymmetrical values such as of (3°, −1°) or (4°, 0°) with respect to the line normal to the solid-state detector 30.

If the grid 28 is moved back and forth in directions perpendicular to the direction in which the radiation-impermeable members 44 extend while the radiation 22 is being applied to the grid 28, as disclosed in Japanese Laid-Open Patent Publication No. 2008-237631, then there may be instances wherein the angle θ is not 0° microscopically, i.e., in a very short period of time, but the angle θ remains to be 0° macroscopically, i.e., on time averaging.

According to the present embodiment, as described above, with the radiation source 24 and the radiation-impermeable members 44 being in such a positional relationship that the orbital plane of the radiation source 24 which is angularly movable and the direction in which the radiation-impermeable members 44 extend are perpendicular to each other, the grid 28 is disposed between the subject 18 to be imaged and the solid-state detector 30, and the radiation source 24 is moved to an angular position through an angle θ which is up to 5° (except 0°) from the normal line of the solid-state detector 30. The radiation source 24 moved to the angular position applies the radiation 22 obliquely to the subject 18. Thus, any angular difference between the direction in which the radiation-impermeable members 44 of the grid 28 are erected and the direction in which the radiation 22 is applied to the grid 28 is small. Therefore, the straightforward component of the radiation 22 which has passed through the subject 18 passes through the radiation-permeable members 42 essentially without being obstructed by the radiation-impermeable members 44, and reaches the solid-state detector 30. The SN ratio of the entire image detecting system including the mammographic apparatus 10 is maintained at a desired level, and as a result, the image processing capability for a body region where the absorption contrast for the radiation 22 is low is prevented from being decreased. The mammographic apparatus 10 is of a simple arrangement and is hence relatively low in cost of manufacturing.

The radiographic image capturing apparatus according to the present invention is not limited to the capturing of images of breasts, but is also applicable to the capturing of images of other body regions.

The radiographic image capturing apparatus may incorporate a biopsy apparatus for accurately acquiring the positional information of a biopsy region based on the image information of an acquired stereographic image Ib, and inserting a biopsy needle into the biopsy region based on the positional information to sample part of a tissue from the biopsy region reliably.

The present invention is also applicable to a tomosynthesis image capturing process for capturing radiographic images Ia by applying the radiation 22 to the subject 18 from the radiation source 24 at different angular positions and adding the captured radiographic images Ia to generate a tomographic image Ic, i.e., a reconstructed image, with a desired sectional plane emphasized. The tomographic image Ic may be reconstructed according to a reconstructing process such as a simple backprojection process or a filtered backprojection process, for example. The simple backprojection process is a process for backprojecting a plurality of radiographic images Ia without applying a reconstruction filter and then adding them into a reconstructed image. There are two types of the filtered backprojection process, i.e., a process for applying a reconstruction filter as a convolution filter to a plurality of radiographic images Ia, backprojecting the radiographic images, and then adding them into a reconstructed image, and a process for Fourier-transforming a plurality of radiographic images Ia into frequency-domain data, applying a reconstruction filter to the frequency-domain data, backprojecting the frequency-domain data, and thereafter adding them into a reconstructed image. Either of these filtered backprojection processes may be employed.

The radiographic image generator 60 may generate a three-dimensional image from the stereographic image Ib according to any of various known image processing technologies including, for example, an image juxtaposition process, an image separation process, a parallax separation process, a polarization display process, etc.

The present invention may employ a stimulable phosphor panel instead of the solid-state detector 30.

Although a certain preferred embodiment of the present invention has been shown and described in detail, it should be understood that various changes and modifications may be made therein without departing from the scope of the appended claims.

What is claimed is:

1. A radiographic image capturing method using a grid for removing scattered rays of a radiation applied to a radiation detector, the grid including an assembly formed by alternately arranging radiation-permeable members and radiation-impermeable members which extend in one direction, the radiographic image capturing method comprising the steps of:
placing the grid between a subject to be imaged and the radiation detector in such a positional relationship that an orbital plane of the radiation source which is angularly movable and the one direction are perpendicular to each other;
moving the radiation source to an angular position through an angle which is up to 5° excluding 0°, from a line normal to the radiation detector; and
applying the radiation from the radiation source which has been moved to the angular position, obliquely to the subject.

2. The radiographic image capturing method according to claim 1, wherein the grid comprises a focused grid in which the radiation-impermeable members are inclined at respective angles that are progressively greater away from a central line of the grid, the central line extending along the one direction.

3. A radiographic image capturing apparatus comprising:
a radiation source for emitting a radiation;
a drive controller for actuating the radiation source to turn along an orbit;
a grid for removing scattered rays of the radiation, the grid including an assembly formed by alternately arranging radiation-permeable members and radiation-impermeable members which extend in one direction; and
a radiation detector for detecting the radiation emitted from the radiation source;
wherein the grid is disposed between a subject to be imaged and the radiation detector in such a positional relationship that an orbital plane of the radiation source and the one direction are perpendicular to each other;
the drive controller moves the radiation source to an angular position through an angle which is up to 5° excluding 0°, from a line normal to the radiation detector; and
the radiation detector detects the radiation which is emitted from the radiation source at the angular position, obliquely to the subject.

4. The radiographic image capturing apparatus according to claim 3, wherein the grid comprises a focused grid in which the radiation-impermeable members are inclined at respective angles that are progressively greater away from a central line of the grid, the central line extending along the one direction.

5. A radiographic image generating method using a grid for removing scattered rays of a radiation applied to a radiation detector, the grid including an assembly formed by alternately arranging radiation-permeable members and radiation-impermeable members which extend in one direction, the radiographic image generating method comprising the steps of:
placing the grid between a subject to be imaged and the radiation detector in such a positional relationship that an orbital plane of the radiation source which is angularly movable and the one direction are perpendicular to each other;
determining at least two angles in a range from −5° through 5° with respect to a line normal to the radiation detector, as turning angles through which the radiation source is to be turned along an orbit; and
moving the radiation source to respective angular positions depending on the determined turning angles, applying the radiation from the radiation source at the angular positions, to the subject, and acquiring radiographic images of the subject depending on the respective turning angles.

6. The radiographic image generating method according to claim 5, further comprising the step of:
generating a reconstructed image by reconstructing the acquired radiographic images depending on the respective turning angles.

7. A radiographic image generating apparatus comprising:
a radiation source for emitting a radiation;
a drive controller for actuating the radiation source to turn along an orbit;
a grid for removing scattered rays of the radiation, the grid including an assembly formed by alternately arranging radiation-permeable members and radiation-impermeable members which extend in one direction; and
a radiation detector for detecting the radiation emitted from the radiation source;
wherein the grid is disposed between a subject to be imaged and the radiation detector in such a positional relationship that an orbital plane of the radiation source and the one direction are perpendicular to each other;
the drive controller moves the radiation source to respective angular positions through at least two turning angles in a range from −5° through 5° from a line normal to the radiation detector; and
the radiation detector detects the radiation which is emitted from the radiation source at each of the angular positions to the subject.

8. The radiographic image generating apparatus according to claim 7, further comprising:
a radiographic image generator for acquiring radiographic images depending on the respective turning angles based on the radiation detected by the radiation detector, and generating a reconstructed image by reconstructing the acquired radiographic images.
